(19) United States
(12) Patent Application Publication
(10) Pub. No.: US 2014/0184005 A1
(43) Pub. Date: Jul. 3, 2014

(54) ROTOR FOR DRIVE MOTOR

(71) Applicant: Hyundai Motor Company, Seoul (KR)

(72) Inventors: Jung Shik Kim, Seoul (KR); Hyoungjun Cho, Seoul (KR); Sanghoon Moon, Seonganam (KR); Kyoungbum Kim, Seonganam (KR)

(73) Assignee: Hyundai Motor Company, Seoul (KR)

(21) Appl. No.: 14/033,720

(22) Filed: Sep. 23, 2013

(30) Foreign Application Priority Data
Dec. 31, 2012 (KR) 10-2012-0158622

(51) Int. Cl. H02K 21/12

(52) U.S. Cl. CPC H02K 21/12
USPC 310/156.01

(57) ABSTRACT

A rotor is provided that includes a rotor core formed in a cylindrical shape so as to be disposed and rotatable in a hollow portion of a hollow cylinder of a stator and a rotating shaft that penetrates a rotational center of the rotor core and rotates together with the rotor core accordingly. Furthermore, permanent magnets are disposed along a circumference of the rotor core and are each divided into a plurality of individual units along an axial direction of the rotor core. In particular, the plurality of individual units includes an intermediate permanent magnet positioned at a center portion in the axial direction. This intermediate permanent magnet is made of a material having coercive force higher than that of the other individual units.

### CROSS-REFERENCE TO RELATED APPLICATION

This application claims priority to and the benefit of Korean Patent Application No. 10-2012-0158622 filed in the Korean Intellectual Property Office on Dec. 31, 2012, the entire contents of which are incorporated herein by reference.

### BACKGROUND

(a) Field of the Invention

The present invention relates to a rotor for a drive motor, and more particularly, to a rotor for a drive motor that is capable of improving performance of a drive motor.

(b) Description of the Related Art

Drive motors are typically used as a power source within hybrid and electric vehicles, and for the most part made up of a stator and a rotor.

The stator is a stationary part that surrounds the outer circumference of a rotor. Depending on the configuration of the motor, the stator may act as a field magnet, interacting with an armature to create rotational motion of the rotor, or stator may alternatively act as the armature itself, receiving its influence from moving field coils on the rotor. Thus, the stator transmits torque so that the rotor is rotated. That is, the rotor is which rotated within the motor based upon how wires and magnetic fields are arranged within the motor so that a torque is developed about the rotor's axis.

The rotor in a drive motor is generally formed in a cylindrical shape, and the stator is formed in a hollow cylindrical shape so that the rotor may be inserted into the stator accordingly.

As mentioned above, an armature coil may be disposed along a circumferential direction of the stator, and permanent magnets may be disposed along a circumferential direction of the rotor. As the permanent magnet is pushed in one direction by a magnetic field formed at the armature coil, the rotor begins to rotate. Moreover, functions of the drive motor may be changed in accordance with configurations of the armature coil and the permanent magnets.

High magnetic flux density is required in the permanent magnets of the drive motor. Meanwhile, demagnetizing force, which attenuates magnetic force, is proportional to the magnetic flux density. In order to prevent loss of magnetic force due to the demagnetizing force, the permanent magnet(s) of a drive motor are typically made of a material which having high coercive force (e.g., magnetically hard materials). Particularly, barium ferrite, which is known as having a high coercive force, is used.

However, the barium ferrite (BaO.6Fe₂O₃) has a lower magnetic flux density than other materials. In addition, as the magnetic flux density is decreased, efficiency of the permanent magnet may deteriorate, and consequently, performance of the drive motor may deteriorate. Therefore, the permanent magnet, which must maintain a high degree of magnetic flux density and maximally prevent a loss of magnetic force due to the demagnetizing force, is required.

Additionally, an eddy current loss sometimes occurs in permanent magnets. Here, the eddy current loss refers to a loss of energy caused by heat generated by an eddy current. Therefore, smooth heat radiation of the permanent magnet is also required in order to reduce the eddy current loss.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to provide a rotor for a drive motor, in which a higher magnetic flux density of a permanent magnet is maintained in comparison to conventional rotors, and a loss of magnetic force due to demagnetizing force is maximally prevented. In addition, the present invention has been made in an effort to provide a rotor for a drive motor, in which heat radiation performance of the permanent magnet is improved.

An exemplary embodiment of the present invention provides a rotor for a drive motor, including: a rotor core formed in a cylindrical shape so as to be disposed and rotatable in a hollow portion of a hollow cylinder of a stator. The rotor also includes rotating shaft that penetrates a rotational center of the rotor core and rotates together with the rotor core. Along a circumference of the rotor core, permanent magnets disposed. These permanent magnets are divided into a plurality of units in an axial direction of the rotor core that include an intermediate permanent magnet positioned at a center portion along the axial direction.

This intermediate permanent magnet is made of a material having coercive force higher than that of the other individual units. Additionally, The other individual units may be made of a material having higher magnetic flux density than the intermediate unit.

In some exemplary embodiments of the present invention, an insulating layer may be formed between each of the individual units, and each of the individual units may be spaced apart from each other at a predetermined distance. The permanent magnet may also radiate heat between each of the individual units to further eliminate heat within the rotor.

### BRIEF DESCRIPTION OF THE DRAWINGS

FIG. 1 is a configuration diagram of a rotor for a drive motor according to an exemplary embodiment of the present invention.

### DESCRIPTION OF SYMBOLS

1: Rotor

10: Rotating shaft

20: Permanent magnet

22: Upper magnet

24: Intermediate magnet

26: Lower magnet

28: Insulating layer

30: Rotor core

### DETAILED DESCRIPTION OF THE EMBODIMENTS

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

An exemplary embodiment of the present invention will hereinafter be described in detail with reference to the accompanying drawings.

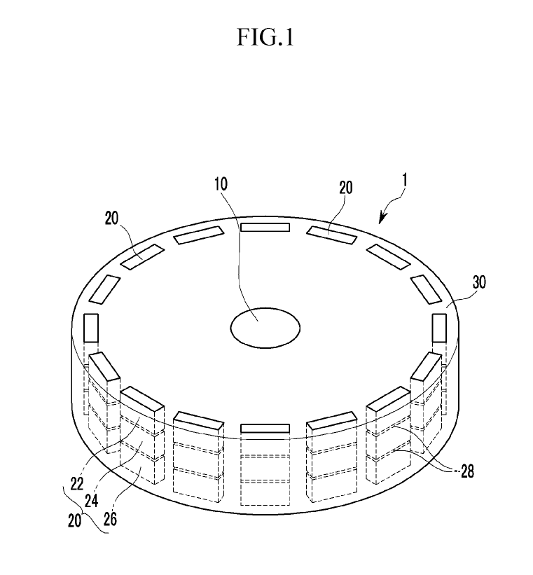

FIG. 1 is a configuration diagram of a rotor for a drive motor according to an exemplary embodiment of the present invention. Although only a rotor 1 for a drive motor according to an exemplary embodiment of the present invention is illustrated in FIG. 1, the rotor 1 is configured to operate a drive motor by being coupled to a stator. Because the configuration of the drive motor including the rotor 1 and the stator is apparent to a person of ordinary skill in the art (hereinafter referred to as the person skilled in the art), a more detailed description will be omitted.

As illustrated in FIG. 1, the rotor 1 for a drive motor according to the exemplary embodiment of the present invention includes a rotating shaft 10, permanent magnets 20, and a rotor core 30. The rotating shaft 10 is provided to penetrate the rotor 1 in an up and down direction in the drawing. In addition, the rotating shaft 10 is disposed at a rotational center of the rotor 1. Moreover, the rotating shaft 10 is rotated together with the rotor 1, and outputs torque from the rotor 1 to the other devices. Here, the up and down direction of the drawing is the axial direction of the rotor 1.

The permanent magnets 20 are made up of a plurality of individual units along a circumferential direction of the rotor 1. In addition, the rotor rotates as the permanent magnets 20 are pushed in one direction by a magnetic field formed on an armature coil (not illustrated) which is disposed along a circumferential direction of a stator.

The rotor core 30 is a body of the rotor 1. In addition, the rotor core 30 is formed in a cylindrical shape so that the rotor 1 is disposed and rotated in a hollow portion of the stator formed in a hollow cylindrical shape of the stator. Moreover, the permanent magnets 20 are mounted in the rotor core 30. That is, the permanent magnets 20 are disposed along a circumferential direction of the rotor core 30 as shown in FIG. 1.

The permanent magnets 20 may be disposed around the entire circumference of the rotor core 30 so as to smoothly receive magnetic force of the armature coil, and each of the permanent magnets 20 may be longitudinally formed along an axial direction of the rotor core 30. In addition, each of the permanent magnets 20 is divided into a plurality of units along a longitudinal direction thereof. FIG. 1 illustrates the permanent magnets 20 which are divided into three units specifically, but the present invention is not limited thereto. Meanwhile, sizes and shapes of the plurality of divided units may be changed to be applied by a person skilled in the art.

Hereinafter, the exemplary embodiment of the present invention will be described based on the permanent magnets 20 which are divided into three units. In particular, the permanent magnets 20 may include an upper magnet 22, a lower magnet 26, an intermediate magnet 24, and an insulating layer 28.

The upper magnet 22 is a permanent magnet disposed at an uppermost end among the three units. In addition, the upper magnet 22 is made of a material having lower coercive force properties than intermediate magnet 24 but magnetic flux density properties that are higher than the intermediate magnet 24. Moreover, when the permanent magnets 20 are divided into three or more units, the upper magnet 22 refers to the unit which is disposed at the upper most portion of the rotor in an axial direction relative to a center unit.

The lower magnet 26 is one of the permanent magnet units that are disposed at a lowermost unit of the three units. In addition, the lower magnet 26 is made of a material having lower coercive force properties than intermediate magnet 24 but a higher magnetic flux density properties than intermediate magnet 24 (much like the upper magnet 22). Moreover, in a case in which the permanent magnets 20 are divided into three or more units, the lower magnet 26 refers to the permanent magnet which is disposed at lowermost portion of the three or more units.

The intermediate magnet 24 is a permanent magnet disposed between the upper magnet 22 and the lower magnet 26 of the three units. In addition, the intermediate magnet 24 is made of a material having lower magnetic flux density than the upper or lower magnets but higher coercive force than the upper or lower magnets. Moreover, in a case in which the permanent magnets 20 are divided into three or more units, the intermediate magnet 24 refers to the unit the permanent magnet 20 this is disposed at the center in the axial direction. Hereinafter, the material of the intermediate magnet 24, which has high coercive force, may be neodymium (NdFeB).

The permanent magnet in the illustrative embodiment of the present invention that is made of neodymium (NdFeB) is able to amplify the magnetic force that is applied compared to the existing permanent magnet. Therefore, the neodymium (NdFeB) is used high magnetic force is required. For example, the neodymium (NdFeB) may be used in medical appliances such as a magnetic resonance imaging (MRI) apparatus.

More specifically, a coercive force refers to intensity of a reverse magnetic field for making a degree of magnetization of a magnetized magnetic material zero. In other words, the coercive force refers to intensity of a magnetic field in a case in which residual magnetization remains on a ferromagnetic material when a magnetic field is set to be zero in a magnetic saturation state of a magnetic material, and magnetization is decreased and becomes zero when the magnetic field is increased again in an opposite direction. Further, the coercive force may have an inherent value that is based on the type of magnetic material that is being used.

Magnetic flux density refers to magnetic flux per unit area of a uniformly magnetized material. That is, as the magnetic flux density of the permanent magnet 20 becomes reaches higher levels, output of the drive motor may be increased. In addition, a demagnetizing force becomes proportional to the magnetic flux density. Here, the demagnetizing force refers to a force that weakens the magnetic force which acts as poles are generated at both ends of a magnetic material when the magnetic material is magnetized in a magnetic field.

In particular, when the intermediate magnet 24 of the permanent magnet 20 is made of a material having high coercive force, a loss of magnetic force due to the demagnetizing force is reduced. In addition, when the upper magnet 22 and the lower magnet 26 of the permanent magnets 20 are made of a material having high magnetic flux density, the overall magnetic flux density of the permanent magnets 20 may be maintained at a higher level than the conventional rotors.

Meanwhile, the upper magnet 22 and the intermediate magnet 24 may be spaced apart from each other at a predetermined distance, and the intermediate magnet 24 and the lower magnet 26 may also be spaced apart from each other at a predetermined distance.

The insulating layer 28 may be made of a material through which electricity is not transmitted. As such, the insulating layer 28 may be interposed between the upper magnet 22 and the intermediate magnet 24 which are spaced apart from each other, accordingly. In particular, this insulating layer 28 is interposed between the intermediate magnet 24 and the lower magnet 26 which are spaced apart from each other. That is, the insulating layer 28 insulates the upper magnet 22 and the intermediate magnet 24, and insulates the intermediate magnet 24 and the lower magnet 26. However, in embodiments where the permanent magnets 20 are divided into three or more pieces, the insulating layer 28 may be interposed between the respective pieces.

Since the permanent magnets 20 are divided into an upper, intermediate, and lower magnet 22, 24, and 26 and are insulated by the insulating layers 28, the upper magnet 22 radiates heat at an upper side of the rotor core 30, and between the upper magnet 22 and the intermediate magnet 24. In addition, the intermediate magnet 24 radiates heat between the upper magnet 22 and the intermediate magnet 24, and between the intermediate magnet 24 and the lower magnet 26. Likewise, the lower magnet 26 radiates heat between the intermediate magnet 24 and the lower magnet 26, and through a lower side of the rotor core 30. Therefore, any eddy current loss can be minimized Here, the eddy current loss refers to a loss of energy caused by heat generated by an eddy current.

As described above, according to the exemplary embodiment of the present invention, as the permanent magnet 20 is divided into upper, intermediate, and lower magnets, heat radiation performance of the permanent magnet 20 may be improved. In addition, since the intermediate magnet 24 is made of a material having a higher coercive force than the upper and lower magnets, a loss of magnetic force due to demagnetizing force may be maximally prevented. Moreover, since the upper and lower magnets 22 and 26 are made of a material having a higher magnetic flux density than the intermediate magnet, a much higher magnetic flux density of the permanent magnet can be maintained, and output of the drive motor can be improved.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A rotor for a drive motor, comprising:
a rotor core formed in a cylindrical shape so as to be disposed and rotatable in a hollow portion of a stator;
a rotating shaft that penetrates a rotational center of the rotor core and rotates together with the rotor core; and
permanent magnets disposed along a circumference of the rotor core,
wherein the permanent magnets are divided into a plurality of individual units along an axial direction of the rotor core, the permanent magnets including an intermediate unit positioned at a center portion along the axial direction of the rotor core, wherein the intermediate unit is made of a material having a coercive force higher than that of the remaining individual units of each permanent magnet.

2. The rotor for a drive motor of claim 1, wherein:
every other permanent magnet is made of a material having a magnetic flux density that is higher than the intermediate permanent magnet.

3. The rotor for a drive motor of claim 1, wherein:
an insulating layer is formed between each of the plurality of individual units.

4. The rotor for a drive motor of claim 1, wherein:
the plurality of individual units are spaced apart from each other at a predetermined distance.

5. The rotor for a drive motor of claim 1, wherein:
the permanent magnets radiate heat between individual units.

6. A motor comprising:
a stator; and
a rotor including:
permanent magnets disposed along a circumference of a rotor core,
wherein the permanent magnets are divided into a plurality of individual units along an axial direction of the rotor core, the permanent magnets including an intermediate unit positioned at a center portion along the axial direction of the rotor core, wherein the intermediate unit is made of a material having a coercive force higher than that of the remaining individual units of each permanent magnet.

7. The motor of claim 6, wherein:
all of the other individual units besides the intermediate unit are made of a material having a magnetic flux density that is higher than the intermediate unit of each permanent magnet.

8. The motor of claim 6, wherein:
an insulating layer is formed between each of the plurality of individual units.

9. The motor of claim 6, wherein:
the individual units are spaced apart from each other at a predetermined distance.

10. The motor of claim 6, wherein the permanent magnets radiate heat between each of the individual units.
